(19) United States
(12) Patent Application Publication
(10) Pub. No.: US 2012/0030231 A1
(43) Pub. Date: Feb. 2, 2012

(54) Accessing Personal Records Without Identification Token

(76) Inventor: Charles Austin Cropper, Midland, TX (US)

(21) Appl. No.: 12/844,917

(22) Filed: Jul. 28, 2010

(51) Int. Cl. G06F 17/30

(52) U.S. Cl. 707/769; 707/E17.014

(57) ABSTRACT

An individual's personal records, e.g. medical, legal, or financial records, can be accessed without resort to a social security number, account number, or other identifying token by presenting questions designed to obtain information related to specific episodes related to the individual's personal history, e.g. medical, legal or financial records. The answers to the questions can be compared to records of the same type belonging to multiple different individuals, and if the answers match to at least a threshold degree of certainty, access to the matched records can be provided to the individual. The questions presented can be specifically tailored based on the language and cultural background of the individual to help ensure accurate results.

### FIELD

The present disclosure relates generally to accessing database records, and more particularly to accessing personal records based on an individual's personal history.

### BACKGROUND

Access to medical, legal, financial, and other records are often controlled using an individual's name, social security number, account number, or other identifying token. Use of a social security number, for example, provides a way to uniquely identify an individual's records, and also provides at least a minimal level of access security, because a person's social security number is generally assumed not to be widely known by others. Social security numbers and other identifying tokens, however, are not secure as secure as some may believe, at least in part because they are commonly used as quasi-identity numbers for most tax transactions, and are therefore accessible by others. Furthermore, if a token is lost or compromised, secure access to the records cannot be ensured.

### SUMMARY

Unlike prior art methods that rely on one or a few tokens to secure access to an individual's personal records, various embodiments of the present disclosure can provide more security for the individual's records because they use multiple pieces of information personal to the individual herself. Some embodiments of the present disclosure, therefore, do not rely on identifying tokens, but instead obtain information about a individual's personal history to verify the identity of the individual.

In view of the above, a method for use in accessing personal records can include presenting multiple questions to an individual to obtain information related to specific episodes in an individual's personal history. The information obtained is compared to personal records associated with multiple different individuals, and matching target records are identified to at least a threshold degree of certainty based at least in part on the information obtained. Having verified the identity of the requestor, the target personal records can be provided to the individual. In some embodiments, the individual's birth date can, but need not, be used to help select the proper target records. In identifying target records, various embodiments specifically avoid using any identification token capable by itself of uniquely identifying the individual.

Some embodiments include determining a language and cultural background of the individual, and presenting the plurality of questions based on the language and cultural background of the individual. At least one of the questions can be presented in a multiple choice format, which may include at least one false answer choice selected to match personal records associated with an individual other than the individual, and a correct answer choice matching the target personal records.

In some embodiments, the method includes presenting a first group of questions, receiving an inconsistent answer to at least one question in the first group of questions, resulting in the answers to the first group of questions being insufficient to identify the target records to the threshold degree of certainty. The method can present a second group of questions, and identify the target records to at least a threshold degree of certainty based on answers to the second group of questions.

Various embodiments of the present disclosure can be implemented as a computer system, which may include a processor, memory, and a communications interface used to access one or more databases storing, among other things, a individual's birth date, at least one date of treatment, a location corresponding to the at least one date of treatment, and a diagnosis corresponding to the at least one date of treatment. Other embodiments can be realized as a computer readable medium tangibly embodying a program of computer executable instructions.

As used herein, the term personal records” includes medical records, legal records, financial records, or other records that include information personal to a particular individual or entity. The term “individual” is generally used in this disclosure to refer to a patient, client, penitent, or the like. Unless otherwise explicitly specified, embodiments referring to “medical records” can also be applied in the context of legal records, financial records, educational records, or other records that may include sensitive information that may require an individual's permission before being released.

### BRIEF DESCRIPTION OF THE DRAWINGS

Aspects of this disclosure will become apparent upon reading the following detailed description and upon reference to the accompanying drawings, in which like references may indicate similar elements:

FIG. 1 is a diagram illustrating a network that can be used by various embodiments of the present disclosure to provide access to a patient's medical records based on the patient's answers to various questions related to his medical history;

FIG. 2 illustrates an Medical Records Initial Query screen according to various embodiments of the present disclosure;

FIGS. 3-5 illustrate various Medical Record Query screens according to embodiments of the present disclosure;

FIG. 6 illustrates an initial Emergency screen according to embodiments of the present disclosure;

FIG. 7 illustrates an Emergency Treatment Identification Questions screen according to embodiments of the present disclosure;

FIG. 8 illustrates an Legal Record Query screen according to embodiments of the present disclosure;

FIG. 9 illustrates an Financial Record Query screen according to embodiments of the present disclosure;

FIG. 10 is a flowchart illustrating various methods according to embodiments of the present disclosure; and

FIG. 11 is a high level block diagram of a processing system according to an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

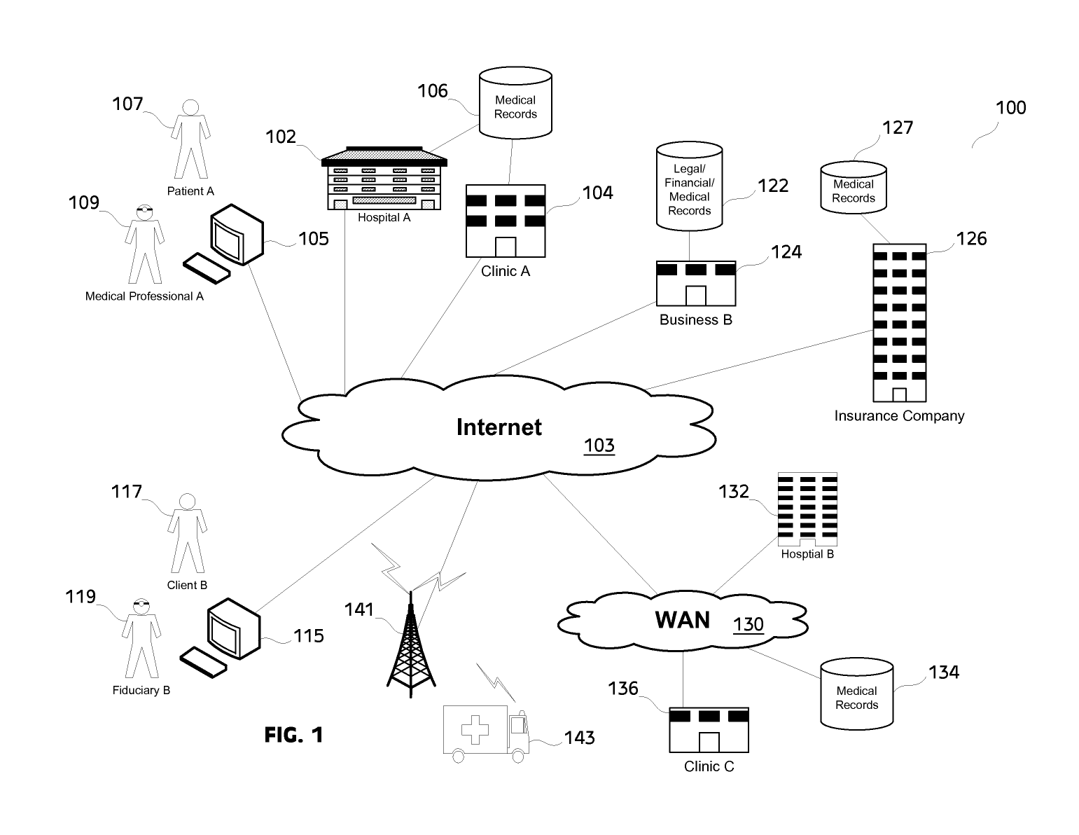

Referring first to FIG. 1, the use of a communication system 100 according to various embodiments of the present disclosure will be discussed. System 100 includes Internet 103, through which patient terminals 105 and 115 are connected for communication to Hospital A 102, Clinic A 104, and Medical Records database 106; Business B 124, and Records database 122; Insurance company 126, and Database 107; Shared database 125; and wide area network (WAN) 130, Hospital B 132, Clinic C 136, and Medical Records database 134. Emergency Responder 143 can communicate to these same elements via radio tower 141 and Internet 103.

Patient A 107 or Client B 117 can retrieve medical, legal, financial, or other personal records from any of various sources based on information about each patient's particular personal history. Consider for example the case where Patient A 107 is visiting Medical Professional A 109 for treatment of a current medical condition. Medical Professional A 109, who has not previously treated Patient A 107 desires to view the medical records of Patient A 107. With Patient A 107 in the office, Medical Professional A 109 can enter via terminal 105 a request for medical records from any of the various clinics or hospitals, or even insurance company 126.

In various embodiments, it is not necessary for Medical Professional A 109 to know the location in which medical records are being stored; instead a general request can be sent to multiple locations, to a centralized medical records database, or to a medical records clearinghouse. In some such embodiments, shared database 125 can be maintained by a medical records service to which Patient A 107 may be a subscriber. In some such embodiments, medical records for Patient A 107 can be stored in the shared database 125 regardless of where the medical records were collected. In some embodiments, medical records can be stored in both shared database 125, and in one or more different locations such as medical records database 106 records database 122, medical records database 134, and medical records database 127.

Regardless of where the medical records for Patient A 107 are being stored, when Medical Professional A 109 sends a request for the medical records, some embodiments return a series of questions to be answered by Patient A 107. These questions can be used to verify that the proper medical records are being provided to Medical Professional A 109. In various embodiments identifying tokens, e.g. name, birth date, Social Security number, insurance policy number, address, or account number, are not used to verify that the proper medical records are provided to Patient A 107. By avoiding the use of particular tokens to retrieve medical records, and instead using patients' own medical histories to identify their medical records, the security of the patients' medical records may be increased.

This increase in security is achieved, in part, because generally a patient is more likely to know the totality of his own medical history, but others are not. For example, Patient B 117 is unlikely to be able to obtain the medical records of Patient A 107, because Patient B 117 is not likely to have knowledge of Patient A 107's medical history. Generally, by requiring a sufficient number of correctly answered questions, the likelihood of properly identifying the medical records of any particular patient can be assured to at least the desired threshold of statistical certainty. Various statistical methods and formulas known to those of skill in the art of statistics and probability related to the field of medical treatment can be used to calculate the number of correct answers needed to establish a desired threshold of certainty. Thus, this disclosure should not be considered limited to using a particular mathematical formula unless otherwise stated.

In some embodiments, the presence of Patient A 107 at the time Medical Professional A 109 is requesting the patient's medical records can be a factor in ensuring that the correct medical records are obtained. For example, depending on the nationality, culture, gender, language capabilities, and other background factors, responses provided by Patient A 107 to questions may vary. Furthermore, various cultures worldwide use different terms to describe similar medical problems, and the average layperson is generally unaware of specific terminology used by medical professionals to refer to particular symptoms and diagnoses. Some embodiments of the present disclosure take advantage of the variability with which patients describe their symptoms and treatments to help ensure that medical records for a particular patient are identified to at least a desired threshold of statistical probability.

The presence of both Patient A 107 and Medical Professional A 109 (a fiduciary) while requesting medical or other personal records can provide an additional safeguard to ensure that medical records are not being requested improperly. In some embodiments, a patient or other individual may not be allowed to access his own records without a fiduciary first vouching for the individual's identity.

Consider an example where Client B 117 seeks treatment for a respiratory condition from Fiduciary B 119. Fiduciary B 119 requests medical records for Client B 117 using terminal 115. Client B 117 tells Fiduciary B 119 that she previously sought treatment for a similar respiratory condition from Clinic A 104 in Denver Colorado, and from Hospital B 132 in London England. Medical Professional B 119 can query both Clinic A 104 and Hospital B 132 for the patient's medical records.

In response to the query received from terminal 115 via Internet 103, Clinic A 104 can query a medical records database 106 to define a subset of medical records including all patients treated for the respiratory conditions similar to the one indicated by Client B 117. Note that in various embodiments, Client B 117 may, but need not, also provide a birth date, or some other personal known information that can be used to narrow the list of potentially matching medical records. Clinic A 104 can use information contained in each record of the subset of medical records to construct a number of medical history related questions, and send those questions to terminal 115.

Because each of the medical records in medical records database 106 includes information about different people, who each have been treated for different symptoms, at different times, in different locations, and potentially resulting in different diagnoses, a series of questions can be constructed to uniquely identify the medical records of any particular patient to a desired threshold of statistical certainty, beyond which it can be assumed that the medical records requested by Client B 117 match target medical records included in medical records database 106. For example, if there are 8,000 patients who have been treated at Clinic A 104 for the same respiratory condition Client B 117 sought treatment. Of those 8000 patients, 50 may have been treated during the same month and year as Client B 117 was treated; 40 may have been treated after presenting the same symptoms presented by Client B 117 at the time of her treatment at Clinic A 104; and 10 of those treated may have been women. Of those 10 women, only 1 may have also been prescribed neonatal vitamins by a doctor at Clinic A 104 during the same year. Thus, it can be seen, that based on a patient's medical history, without requiring an identifying token such as a name, Social Security number, home address, or the like, the patient's medical records can be uniquely identified to at least a threshold statistical certainty.

Likewise, in response to a query by Fiduciary B 119, Hospital B 132 may construct queries and challenges based on medical records maintained in medical records database 134. In some embodiments, the identification of target medical records at Clinic A 104 and Hospital B 132 can be cross checked against each other to further verify accuracy and likelihood that the correct medical records are being provided to Client B 117.

If the medical records of Client B 117 are obtained by Fiduciary B 119 from various different sources, those records can be aggregated into a single database to facilitate future requests for the medical records. Thus, should Client B 117 travel abroad and need her medical records in the future, Client B 117 can have a physician or other medical professional in the country she is visiting send a query for medical records to the offices of Fiduciary B 119, which can provide the records on a near immediate basis in a manner similar to that previously discussed. Some such embodiments can save a significant amount of time and allow medical records to be transferred quickly and efficiently, without requiring multiple levels of bureaucratic red tape.

In some cases, an individual may not be available to answer questions about his personal history, for example if the individual is being medically treated at the scene of an emergency. In some such instances, knowledge of the patient's medical records can be important to providing a proper treatment. Various embodiments provide emergency responder 143 with access to the various databases, allowing emergency responder 143 to query for the medical records of the patient via radio tower 141 and Internet 103. E responder 143 may still be able to access the patient's medical records by obtaining information about the patient's medical history from sources other than the patient himself, for example from a relative, friend or from information found on the patient's person.

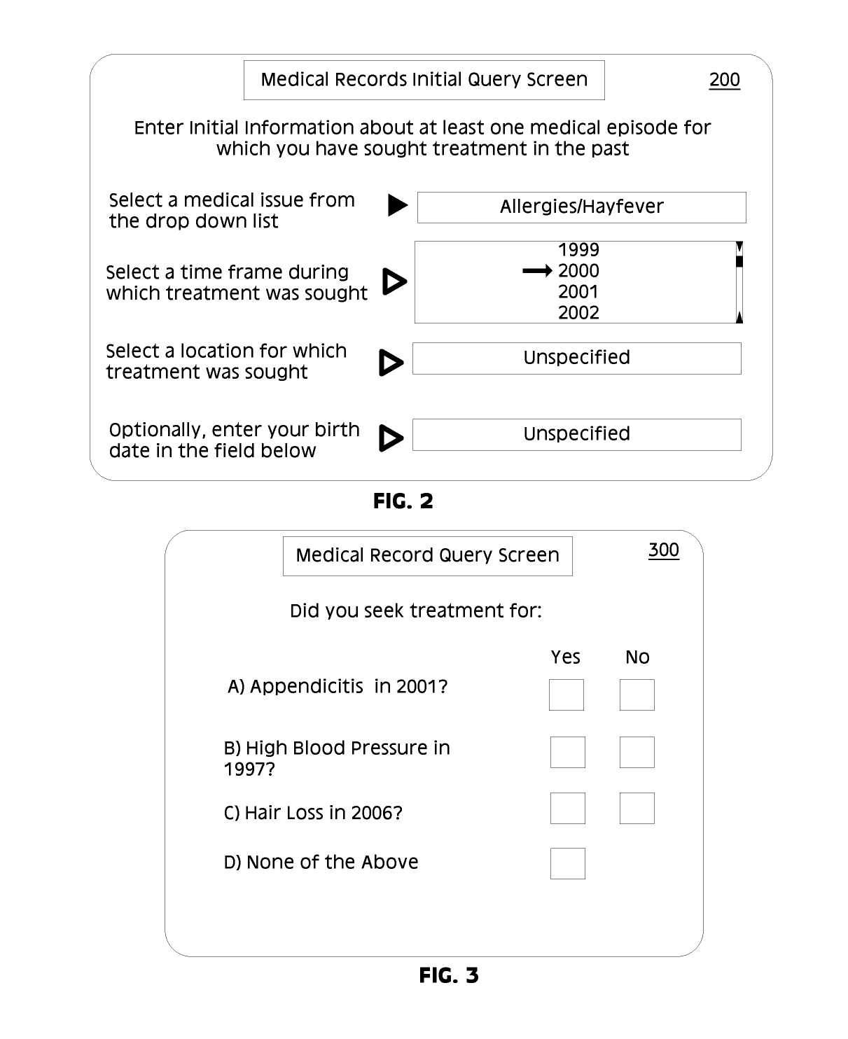

In various embodiments, a lower, i.e. easier to meet, threshold of statistical certainty can be used in obtaining the patient's medical records, which may be particularly useful in time sensitive or emergency situations. Security of the records is still maintained because of the added security of knowing that emergency responders themselves have been authenticated, in some cases by requiring an attestation by the emergency responder. This lower level of statistical certainty can be achieved by asking “easier” questions, such as questions that are more likely to be known by a spouse, friend, or person other than the patient himself, by requiring fewer correct answers to questions, or by providing questions having a broader range of correct answers. In some such embodiments identifying tokens such as a person's name may be used in addition to the patient's medical history to properly identify and provide the records of the patient to the emergency responder 143. Challenge questions and answers for both nonemergency and emergency situations will be discussed further with reference to FIGS. 2-7.

Note that although FIG. 1 primarily addresses the case of medical records, similar techniques can be applied to legal, financial, or other records. For example, Fiduciary B may be a legal or financial provider, a cleric, doctor, nurse, or other trusted individual. Fiduciary B can assist Client B in obtaining medical, financial, legal, or other sensitive records from records database 122 in a manner similar to that discussed with respect to obtaining medical records. In some embodiments, secure access to various records can be maintained by requiring Fiduciary B for initial access to a database, while Client B′s answers to questions are used to control access to specific records within the database.

Referring next to FIG. 2, a medical records initial query screen 200 is illustrated according to an embodiment of the present disclosure. Medical records initial query screen 200 can be used by a medical provider or patient to initiate a request for medical records from one or more databases. In the illustrated embodiment, medical records initial query screen 200 asks the patient to provide initial information about at least one medical episode for which the patient has sought treatment in the past. This information can be used as a basis for performing an initial culling of medical records, and for constructing additional questions to further narrow down the list of records that might belong to a particular patient.

By way of example, a patient may be requested to select from a drop-down menu a particular medical issue, a time frame during which treatment for that medical issue was sought, a location at which treatment was sought, and the patient's birth date. In some embodiments a patient may only be asked to enter her birth date, birth month, or year of birth. In other embodiments, a patient may be asked about his or her gender. In yet further embodiments, the particular medical issue may not be requested, but one or more symptoms or diagnoses, a treating physicians name, or the like.

In other embodiments, although not illustrated, the medical records initial query screen 200 may take a more interactive approach, and simply present a basic question asking the patient, “What is the problem for which you are seeking treatment? The patient's answer to this basic question can be used to seed further questions that will eventually lead to the specific identification of that patient's medical records to at least a threshold degree of certainty. So, for example, a first question, “Where do you normally receive healthcare?” could be followed by another question, “Have you ever experienced this symptom before?” A second follow on question might ask, “When did you last have this problem?” And so on until enough information is obtained about the patient to uniquely identify that patient's medical records. Additionally, the way in which the patient answers the questions can be used to identify cultural, linguistic, or other characteristics that can help the system to generate questions more likely to be understood by the patient.

Referring next to FIG. 3, and continuing with the previous example, after the medical records initial query screen 200 has been presented, a medical record query screen 300 can be presented based on information gleaned from medical records contained in a database being queried. So, for example, all the medical records for individuals who have suffered from allergies and hay fever during the year 2000 can be queried, and questions constructed to differentiate between the various medical records of individuals who were treated for hay fever during the year 2000. So, for example the medical record query screen 300 may present multiple choice questions such as, “Did you receive treatment for: A) appendicitis in 2001?; B). high blood pressure in 1997?; C) hair loss in 2006; or D) none of the above.” The answers to these questions can be used to further narrow the list of potentially matching records, and to identify a target record uniquely matching the patient's medical records. Or, if additional questions are needed to achieve a desired threshold of certainty, additional questions can be generated.

Note that the questions presented medical record query screen 300, and in other embodiments, can be presented as multiple choice, short answer, true or false or in another suitable format. In general, the questions can be designed and presented in a way to obtain correct answers from a patient, but in a way that people other than the patient may not be able to answer correctly. For example, the patient may have been treated for appendicitis in 2003. Others may know that the patient has had appendicitis, but may not know when. Someone other than the patient may, therefore, answer “yes” to question A, even though the patient himself would have known to answer “no”. Likewise the patient may have been treated for high cholesterol in 1997, but not high blood pressure. Someone other than the patient may know that some treatment was sought in 1997, but might not know what the treatment was for. Thus, someone other than the patient would be tempted to select B as true, even though it was not. Question C is likewise designed to elicit a correct response only from the patient. If however none of the 3 questions, A, B, or C, presented on medical record query screen 300 are completely correct selecting answer D, “None of the Above,” would be the correct choice, and can also be used to narrow down the number of records being considered as potentially matching target records.

In some embodiments, responses to questions can be used to help identify and flag identity theft, or accidental commingling of medical records. For example, an individual attempting to retrieve her medical records may not be able to answer enough questions to identify her records to the desired degree of statistical certainty if her records have been accidentally commingled with the record of another individual, or if incorrect information has been introduced into her records due to identity theft. In some such embodiments, one or more sets of records may be flagged as suspect. For example, if the universe of potentially matching records has been narrowed down to two sets, but neither set of records can be determined to the desired threshold of statistical certainty to be the target records, both sets of records can be flagged for further review.

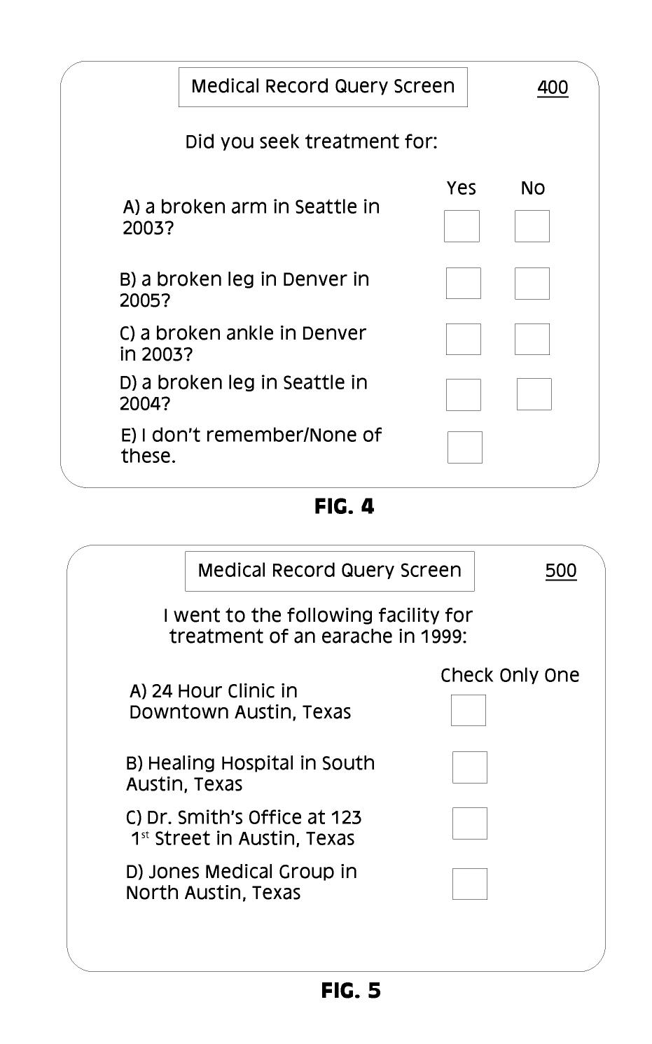

Referring next to FIG. 4, a subsequent medical record query screen 400 can be presented asking if the patient sought treatment for: A) a broken arm in Seattle in 2003; B) a broken leg in Denver in 2005; c) a broken ankle in Denver in 2003; D) a broken leg in Seattle in 2004; or E) I don't remember/None of these. As with medical record query screen 300 illustrated in FIG. 3, correct answers can be used to help identify matching target medical records to a threshold level of statistical certainty.

Referring next to FIG. 5, medical record query screen 500 illustrates how questions related to the location of treatment can be used to help narrow the number of medical records potentially matching the patient's medical records, or as an aid to increasing the confidence level of a match. For example, if medical records have been narrowed down to a point where treatment for a particular illness during a particular time frame is known, questions about treatment location can be used to verify that the person requesting records truly is the patient. As illustrated in FIG. 5, one possible question form might begin, “I went to the following facility for treatment of earache in 1999,” and be followed by a multiple potentially correct answers. asking the requestor to choose between 4 different locations for treatment. Note, that as illustrated in FIG. 5, not all medical record query screens use a “none of the above” type option.

Referring next to FIG. 6, initial emergency screen 600 is illustrated according to an embodiment of the present disclosure. In the illustrated emergency screen, the patient's birth date is requested. Additionally, spaces are provided to type conditions for which treatment has been previously sought, previous treatment locations, and treatment dates. Various standards of correctness can be set depending on the level of certainty desired. These standards can define how many conditions, locations, and dates of treatment need to be correct to be considered a match. The information entered in initial emergency screen 600 can also be used as a basis for formulating additional questions and narrowing a number of records to be compared.

Note that in some embodiments, a lesser threshold of certainty for emergency situations may dictate for example that a date of 1999 may be considered correct, even though the actual date of treatment was in 1998 or 2000. Likewise, if any two of the condition, location and date are correct, all three entries can be treated as if the correct answer was provided. In some embodiments, various weighting factors can be provided to condition, date, and location. Some implementations may use countries, states, continents, geopolitical regions, or the like as locations, so that if treatment for a particular condition was sought in Heidelberg, Germany, a location of “Europe” would be considered correct. Various other factors, in addition to the preciseness of the questions and responses, can also be taken into account.

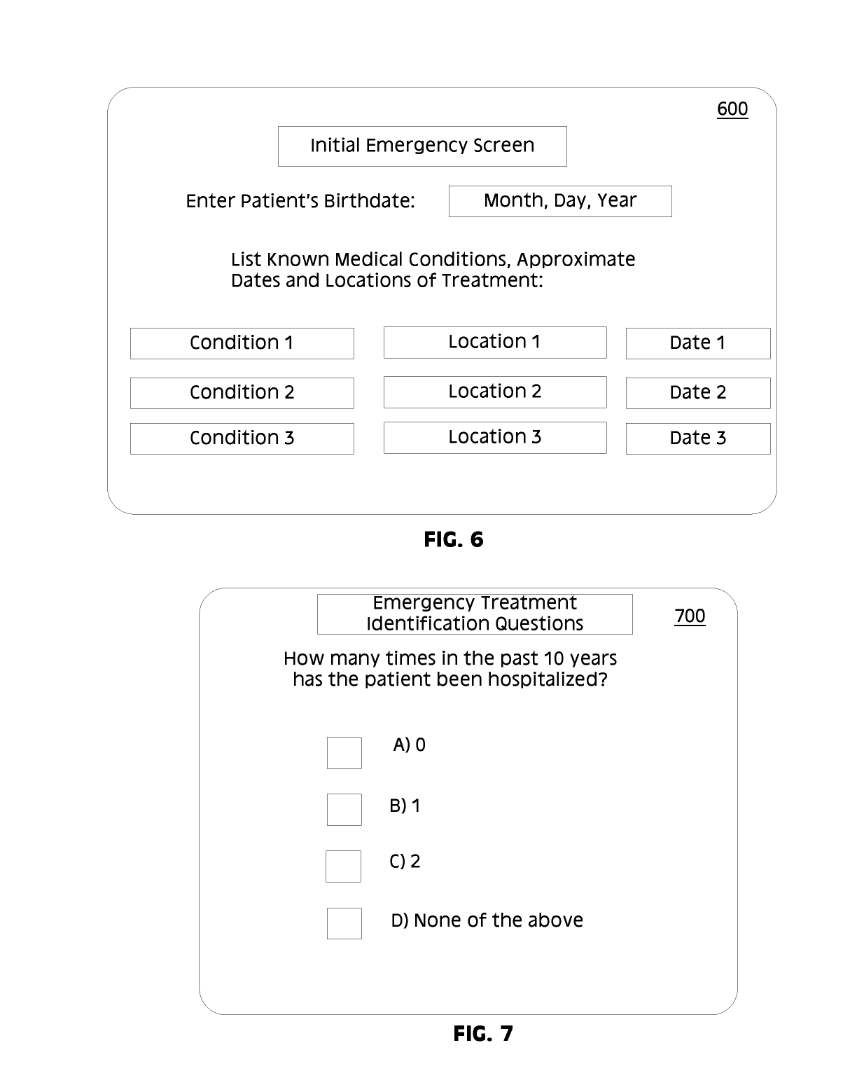

Referring next to FIG. 7, a sample emergency treatment identification questions screen 700 is presented. The question “How many times in the past 10 years has the patient been hospitalized,” is an example of a question that is simpler than most questions presented in non-emergency contexts. Using simplified questions is another way of lowering the threshold of certainty for emergency situations.

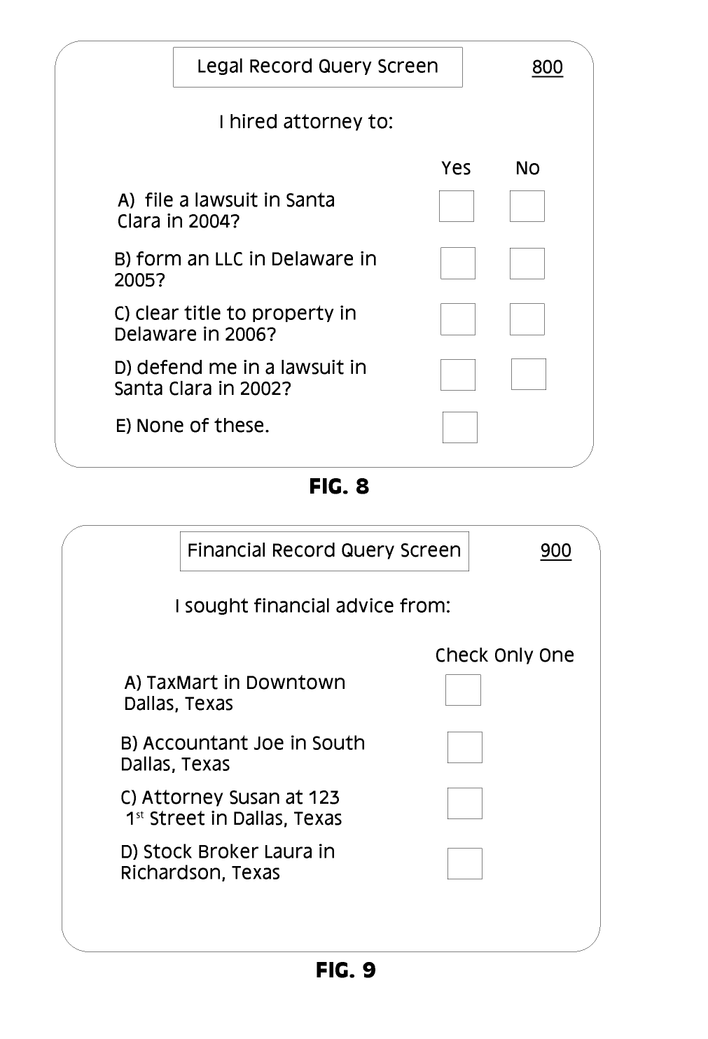

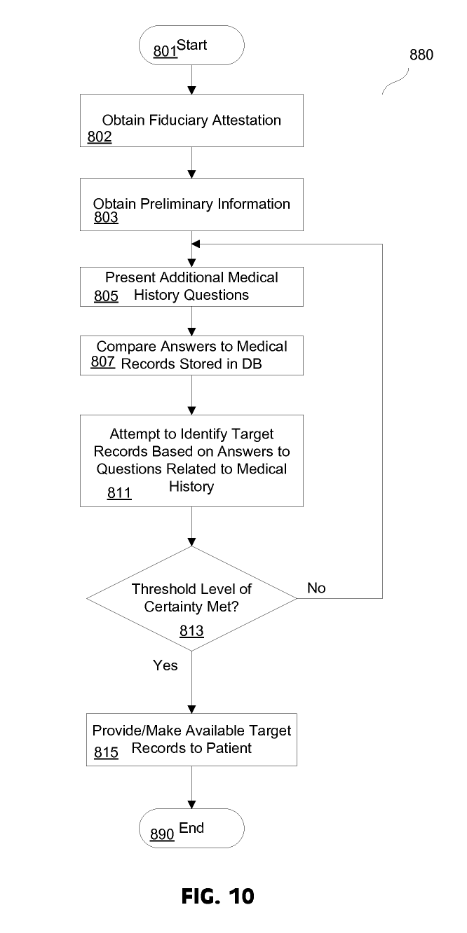

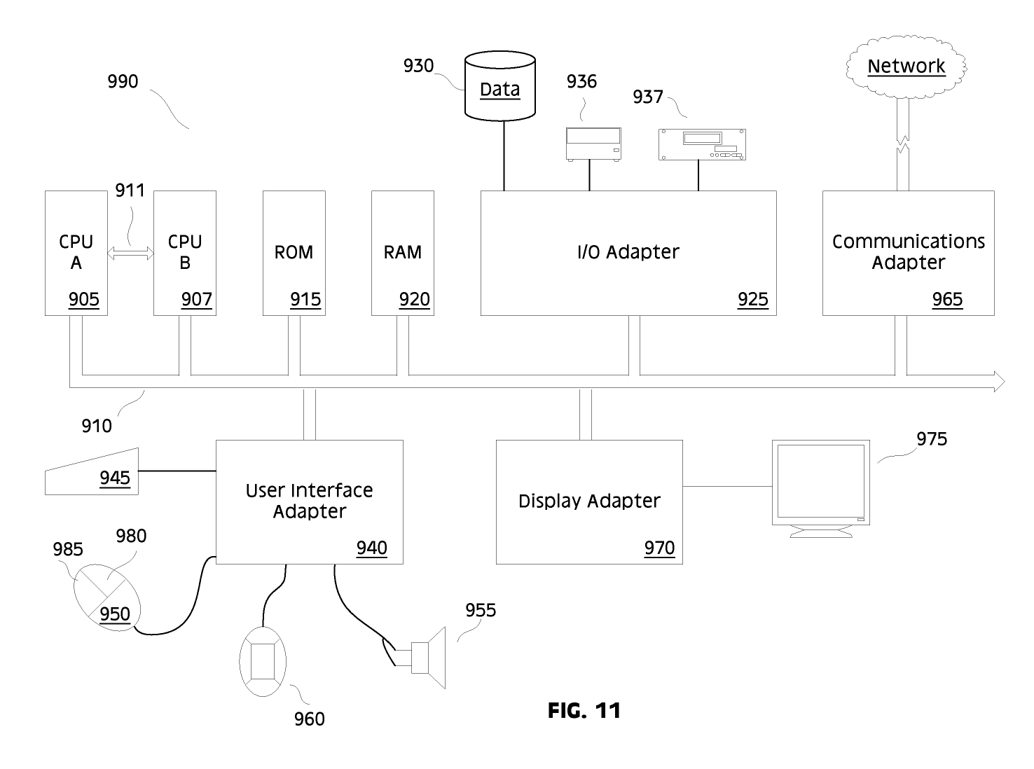

Referring next to FIGS. 8 and 9, sample Legal Record Query Screen 800 and Financial Record Query Screen 900 are shown, illustrating use of questioning and other techniques described herein to control access to legal and financial records.

Referring next to FIG. 9, a method 880 will be discussed according to various embodiments of the present disclosure. Method 880 begins at block 801 and proceeds to block 802. As illustrated by block 802, a fiduciary attestation can be obtained. In some embodiments, obtaining an attestation form a fiduciary, e.g. a doctor, nurse, clergyman, or the like, includes asking the fiduciary to vouch for the identity of an individual seeking to obtain personal records. This can include the fiduciary submitting a statement that the he has obtained some form of identification sufficient to verify the identity of the individual seeking records.

As illustrated in block 803, preliminary information is obtained from the patient. As previously discussed, this preliminary information may include a birth date, and details regarding at least one prior incident of medical treatment. In some embodiments, for example when an emergency responder is requesting records on the half of an unresponsive patient, the preliminary identification information may also include a token, such as the patient's name. However, in most embodiments no identifying token is used to identify the patient's requested medical records.

As illustrated by block 805, additional medical history questions can be presented to further narrow the universe of potentially matching medical records. These additional medical history questions can be designed to be answerable by the person whose medical history is being requested, but not be easily answered by others. Depending on the format of the questions, the types of answers returned, and other factors, multiple additional questions can be used as desired. In some embodiments, if a single screen with multiple different questions is sufficient to establish that particular medical records do in fact belong to a requesting patient, no additional questions might be used.

As illustrated by block 807, answers to the medical history questions can be compared to medical records of different individuals stored in any of various different databases. These databases may be under the control of various hospitals or clinics. In some embodiments, the database may be a shared database, or the query can be handled by a data aggregator or consolidator which in turn may access multiple different databases. Although not illustrated, various embodiments also access either the same or different medical databases to obtain information used to generate the additional questions presented at block 805.

As illustrated by block 811, an attempt is made to identify target records based on answers to questions related to the patient's medical history. In some embodiments, the attempt to identify the target records is based on the comparison between the medical history stored in a database and answers to the medical history questions. As illustrated by block 813, a check is made to determine if target medical records match the medical history questions to at least a threshold level of certainty. If not method 880 returns to block 805, were additional questions can be presented until the target records have been identified as matching the patient's medical history to at least the threshold degree of certainty. Although not specifically illustrated, in some instances, after a certain number of failed attempts to identify target medical records, the method proceeds to block 809.

As further illustrated by block 813, if the threshold level of certainty is met, method 800 proceeds to block 815, where the medical records of the patient are provided to, or otherwise made available to, the requesting patient. Method 800 ends at block 890.

Referring now to FIG. 9, a high-level block diagram of a processing system is illustrated and discussed. Processing system 900 includes one or more central processing units, such as CPU A 905 and CPU B 907, which may be conventional microprocessors interconnected with various other units via at least one system bus 910. CPU A 905 and CPU B 907 may be separate cores of an individual, multi-core processor, or individual processors connected via a specialized bus 911. In some embodiments, CPU A 905 or CPU B 907 may be a specialized processor, such as a graphics processor, other co-processor, or the like.

Processing system 990 includes random access memory (RAM) 920; read-only memory (ROM) 915, wherein the ROM 915 could also be erasable programmable read-only memory (EPROM) or electrically erasable programmable read-only memory (EEPROM); and input/output (I/O) adapter 925, for connecting peripheral devices such as disk units 930, optical drive 936, or tape drive 937 to system bus 910; a user interface adapter 940 for connecting keyboard 945, mouse 950, speaker 955, microphone 960, or other user interface devices to system bus 910; communications adapter 965 for connecting processing system 990 to an information network such as the Internet or any of various local area networks, wide area networks, telephone networks, or the like; and display adapter 970 for connecting system bus 910 to a display device such as monitor 975. Mouse 950 has a series of buttons 980, 985 and may be used to control a cursor shown on monitor 975.

It will be understood that processing system 990 may include other suitable data processing systems without departing from the scope of the present disclosure. For example, processing system 990 may include bulk storage and cache memories, which provide temporary storage of at least some program code in order to reduce the number of times code must be retrieved from bulk storage during execution.

Various disclosed embodiments can be implemented in hardware, software, or a combination containing both hardware and software elements. In one or more embodiments, the invention is implemented in software, which includes but is not limited to firmware, resident software, microcode, etc. Some embodiments may be realized as a computer program product, and may be implemented as a computer-usable or computer-readable medium embodying program code for use by, or in connection with, a computer, a processor, or other suitable instruction execution system.

For the purposes of this description, a computer-usable or computer readable medium can be any apparatus that can contain, store, communicate, or transport the program for use by or in connection with an instruction execution system, apparatus, or device. By way of example, and not limitation, computer readable media may comprise any of various types of computer storage media, including volatile and non-volatile, removable and non-removable media implemented in any suitable method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Various embodiments have been described for accessing medical records using information about the patient's medical history. Other variations and modifications of the embodiments disclosed may be made based on the description provided, without departing from the scope of the invention as set forth in the following claims.

What is claimed is:

1. A method for use in accessing personal records, the method comprising:
presenting a plurality of questions to obtain information related to specific episodes in a individual's personal history related to the personal records;
comparing the information to personal records stored in at least one database and associated with a plurality of individuals;
identifying, based at least in part on the comparing, target personal records matching the information related to specific episodes in the individual's personal history to at least a threshold degree of certainty; and
providing the target personal records to the individual.

2. The method of claim 1, further comprising:
the information related to specific episodes is devoid of an identification token capable by itself of uniquely identifying the individual; and
the identifying based solely on comparing information about the individual's personal history to personal records stored in the at least one database.

3. The method of claim 1, further comprising:
determining a language and cultural background of the individual; and
presenting the plurality of questions based on the language and cultural background of the individual.

4. The method of claim 1, further comprising:
presenting at least one of the plurality of questions in a multiple choice format, the multiple choice format including:
at least one false answer choice selected to match personal records associated with an individual other than the individual; and
a correct answer choice matching the target personal records.

5. The method of claim 1, further comprising:
presenting a first group of questions;
receiving an inconsistent answer to at least one question in the first group of questions, wherein answers to the first group of questions are insufficient to identify the target personal records to the threshold degree of certainty;
presenting a second group of questions;
receiving answers to each question of the second group of questions that are consistent with the individual's personal history;
identifying the target personal records to at least a threshold degree of certainty based at least on answers to the second group of questions.

6. The method of claim 1, further comprising:
the at least one database comprising medical records including the individual's birth date, at least one date of treatment, a location corresponding to the at least one date of treatment, and a diagnosis corresponding to the at least one date of treatment.

7. The method of claim 1, further comprising:
flagging at least one set of personal records as suspect in response to the comparing failing to match the at least one set of personal records to the at least a threshold degree of certainty.

8. A system comprising:
a processor;
memory operably associated with the processor;
a program of instructions to be stored in the memory and executed by the processor, the program of instructions including:
at least one instruction to present a plurality of questions to obtain information related to specific episodes in a individual's personal history related to the personal records;
at least one instruction to compare the information to personal records stored in at least one database and associated with a plurality of individuals;
at least one instruction to identify, based at least in part on the at least one instruction to compare, target personal records matching the information related to specific episodes in the individual's personal history to at least a threshold degree of certainty; and
at least one instruction to provide the target personal records to the individual.

9. The system of claim 8, wherein:
the information related to specific episodes is devoid of an identification token capable by itself of uniquely identifying the individual; and
at least one instruction to identify the target personal records based solely on comparing information about the individual's personal history to personal records stored in the at least one database.

10. The system of claim 8, further comprising:
at least one instruction to present the plurality of questions based on a language and cultural background of the individual.

11. The system of claim 8, further comprising:
at least one instruction to present at least one of the plurality of questions in a multiple choice format, the multiple choice format including:
at least one false answer choice selected to match personal records associated with an individual other than the individual; and
a correct answer choice matching the target personal records.

12. The system of claim 8, further comprising:
at least one instruction to present a first group of questions;
at least one instruction to receive an inconsistent answer to at least one question in the first group of questions, wherein answers to the first group of questions are insufficient to identify the target personal records to the threshold degree of certainty;
at least one instruction to present a second group of questions;
at least one instruction to receive answers to each question of the second group of questions that are consistent with the individual's personal history;
at least one instruction to identify the target personal records to at least a threshold degree of certainty based at least on answers to the second group of questions.

13. The system of claim 8, wherein:
the at least one database comprises medical records including the individual's birth date, at least one date of treatment, a location corresponding to the at least one date of treatment, and a diagnosis corresponding to the at least one date of treatment.

14. The system of claim 8, further comprising:
at least one instruction to flag at least one set of personal records as suspect in response to the at least one instruction to compare failing to match the at least one set of personal records to the at least a threshold degree of certainty.

15. A computer readable medium tangibly embodying a program of instructions, the program of instructions comprising:
at least one instruction to present a plurality of questions to obtain information related to specific episodes in a individual's personal history;
at least one instruction to compare the information to personal records stored in at least one database and associated with a plurality of individuals;
at least one instruction to identify, based at least in part on the at least one instruction to compare, target personal records matching the information related to specific episodes in the individual's personal history to at least a threshold degree of certainty; and
at least one instruction to provide the target personal records to the individual.

16. The computer readable medium of claim 15, wherein:
the information related to specific episodes is devoid of an identification token capable by itself of uniquely identifying the individual; and
at least one instruction to identify the target personal records based solely on comparing information about the individual's personal history to personal records stored in the at least one database.

17. The computer readable medium of claim 15, further comprising:
at least one instruction to present the plurality of questions based on a language and cultural background of the individual.

18. The computer readable medium of claim 15, further comprising:
at least one instruction to present at least one of the plurality of questions in a multiple choice format, the multiple choice format including:
at least one false answer choice selected to match personal records associated with an individual other than the individual; and
a correct answer choice matching the target personal records.

19. The computer readable medium of claim 15, further comprising:
at least one instruction to present a first group of questions;
at least one instruction to receive an inconsistent answer to at least one question in the first group of questions, wherein answers to the first group of questions are insufficient to identify the target personal records to the threshold degree of certainty;
at least one instruction to present a second group of questions;
at least one instruction to receive answers to each question of the second group of questions that are consistent with the individual's personal history;
at least one instruction to identify the target personal records to at least a threshold degree of certainty based at least on answers to the second group of questions.

20. The computer readable medium of claim 15, wherein:
the at least one database comprises medical records including the individual's birth date, at least one date of treatment, a location corresponding to the at least one date of treatment, and a diagnosis corresponding to the at least one date of treatment.

21. The computer readable medium of claim 15, further comprising:
at least one instruction to flag at least one set of personal records as suspect in response to the at least one instruction to compare failing to match the at least one set of personal records to the at least a threshold degree of certainty.
